(19) United States
(12) Patent Application Publication
(10) Pub. No.: US 2007/0158339 A1
(43) Pub. Date: Jul. 12, 2007

(54) Cooking utensil for use in microwave oven

(76) Inventor: Paul Beckman, Pleasanton, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/326,758

(22) Filed: Jan. 6, 2006

(51) Int. Cl. H05B 6/80

(52) U.S. Cl. 219/734

(57) ABSTRACT

This invention relates to a cooking utensil, and more particularly, to an improved cooking utensil for use in cooking sliced pepperoni, salami or the like by microwave energy. The invention comprises a base that supports a cooking surface and lid, and collects the grease released during the cooking process.

### 1. BACKGROUND OF THE INVENTION

This invention relates to a cooking utensil, and more particularly, to an improved cooking utensil for use in cooking sliced pepperoni, salami or the like by microwave energy.

### a. Description of the Prior Art

Microwave cooking has now become widely accepted for the preparation of foods in restaurants, domestic use and institutional use. The electromagnetic waves at microwave frequencies assigned by the federal regulatory agencies are radiated within an enclosure from a source of energy such as a magnetron. The cooking is accomplished by high frequency oscillating movements of the molecules in the product being cooked.

Since microwave ovens offer the convenience of relatively quick cooking and relatively low energy, their use is increasing. One of the difficulties heretofore associated with microwave cooking is related to products in which fats are generated or expressed from the product during cooking and which tend to splatter over the interior of the microwave oven. For example, if slices of pepperoni, salami, or the like are cooked in a flat surface type microwave ovenware, grease tends to accumulate at the bottom of the utensil and is in contact with the pepperoni and splatters over the interior surface of the microwave oven and is ultimately charred to a dark residue which is difficult to remove. For purposes of brevity, hereinafter, the term “pepperoni” will include not only pepperoni (sliced), but also sliced salami and other fat containing flat or sliced foods.

There have been efforts in the prior art to invent a cooking utensil, for use in microwave ovens, that is designed to cook bacon. However, given the differences in the dimensions between bacon and pepperoni/salami slices, the utensils designed for cooking bacon would not be useful for the purposes of this invention. For instance, the Oda U.S. Pat. No. 4,112,833 is designed such that the bacon strips can be draped over vertical walls within the apparatus. Not only is this a vastly different concept, this type of apparatus would simply not work when cooking items such as pepperoni or salami slices.

One approach taken has been to place the pepperoni on paper napkins or a paper plate and insert the microwave cookware with paper napkins thereon or paper plates into the oven for preparation of the product.

More specifically, towels and paper plates are frequently used in order to avoid grease splattering on the interior of the oven. Some of the difficulties with this procedure include the limited number of slices that can be prepared, and grease still tends to spill even with these efforts.

Accordingly, a need exists for a unique utensil capable of cooking pepperoni and the like that prevents splattering of the grease, and which may be easily stored and easily cleaned.

### 2. SUMMARY OF THE INVENTION

In accordance with the present invention a unique utensil is provided, principally to be used in microwave cooking of pepperoni and the like by microwave energy.

In brief, the cooking utensil of the present invention includes a base which supports a cooking surface. The base also acts as a reservoir for collecting grease. Said grease includes, but is not limited to, fats that emanate from foods during the cooking process. The base may also comprise a sloped lip, extending from the top of the base. The slope of the lip is generally downward towards the center of the base. This configuration will allow the grease that drips down from the cooking surface to land on the lip and continue down into the reservoir. This configuration will also allow the unit to be tilted (in the direction of the lip), without grease spillage from the reservoir. Also, in an embodiment that includes a drain/plug in the base, the lip would allow for easier removal of grease from the reservoir, while minimizing grease leakage/spilling.

The cooking surface is located above the base (grease reservoir). The distance from the base to the cooking surface should be sufficient to allow separation between the liquefied grease reservoir. The pepperoni is positioned on the cooking surface. The cooking surface will allow liquefied grease to flow through the surface and into the grease reservoir. An embodiment for the cooking surface includes a mesh type surface. Other embodiments include any surface penetrable by liquid grease. These embodiments must be usable and transparent to microwave energy used in most microwave ovens. Another embodiment of this invention allows the cooking surface to be made part of the base structure, as opposed to a separate piece.

The components of the utensil are also microwave transparent in the sense that they are made of a material which will permit passage of the microwave energy through it. Another embodiment allows the utensil to be made of a material that is visually transparent. A visually transparent utensil, especially a lid, would allow the user to perform visual inspections during the cooking process.

During cooking, the pepperoni is supported out of contact with the grease which flows downwardly by gravity into the reservoir as quickly as it is formed. Thus, during a cooking operation, the pepperoni is not continually in contact with a substantial amount of grease.

Any tendency of grease to splatter is reduced since the pepperoni is arranged such that the splattering is caught by the apparatus, including the lid/cover. One embodiment of the lid includes having a handle component, preferably on top of the lid, to allow for easy covering and removal.

The utensil itself is preferably made of ceramic or glass or plastic, it being understood that the material used to fabricate the utensil should be stable against deformation by hot grease, and microwave energy transparent.

In a preferred form, the utensil is generally circular in shape which makes it ideal for use in microwave ovens that utilize a rotating carousel, in that the circular shape would maximize the cooking area available to the user. However, the circular shape is not a requirement of the invention. In fact, an alternate embodiment includes an oval shape, that allows the various elements of the apparatus to fit together in a predictable configuration. One configuration includes one or more handles on the base that could allow the user to easily remove the utensil from the microwave oven after the cooking is complete. This handle component on the base of the utensil could include a protrusion and/or indentation(s) that would allow the user to more easily manipulate the utensil. An embodiment includes one or more base handles located on the sides of the base. These handles could be tilted upward at an angle so as to minimize the total circumference of the apparatus.

Another element of the invention includes a means for stacking cooking surfaces and/or the entire apparatus such that multiple layers of cooking surfaces can be cooked simultaneously in a single microwave oven. This may take the form of stacking the cooking surfaces on top of each other (with the lid on top of the top-most cooking surface). Such a configuration would be best implemented wherein the vertical sides of the cooking surfaces continued without interruption from the base, and formed a solid barrier to the grease from the base to the cover/lid. An embodiment of the invention includes a plurality of notches on the bottom edge of the lid, as well as one or more corresponding ridges located on the top edge of the base. This embodiment allows the base and lid to fit securely together. An alternate embodiment includes a plurality of ridges on the bottom edge of the lid, and corresponding notches on the top edge of the base. Similarly, this alternate embodiment allows the base and lid to fit securely together.

The means for vertically stacking the cooking surfaces may also entail stacking multiple independent apparatuses. This configuration would best be implemented when the lid of one utensil and the base of a second utensil fit together such that they can be securely stacked. One such embodiment includes one or more indentations on the bottom edge of the base of the utensil, and matching protrusion(s) on the lid. Conversely, another embodiment could reverse the indentation(s)/protrusion(s), wherein the protrusion(s) could come from the base, and the lid could have the indentation(s). It is anticipated that the preferred configuration will incorporate the protrusion(s)/indentation(s) on the outside edge of the utensil.

Another configuration for vertically stacking the utensils includes a means for interlocking the base of one utensil with the lid of a second utensil. This interlocking feature could allow multiple utensils to be carried at one time. One embodiment to accomplish this includes one or more C-shaped hooks protruding from the base of the upper unit. The lid could contain notches sized and shaped to allow the user to hook the lid and base together by rotation. This configuration also anticipates that an individual utensil's lid and base have a means for interlocking as well. The above described means for interlocking the bottom of the base to the top of the lid could also be utilized to interlock an individual utensil's base and lid.

Further objects and advantages of the present invention will be best understood by reference to the following specification taken in connection with the accompanying drawings.

### 3. BRIEF DESCRIPTION OF THE DRAWINGS

FIG. 1 illustrates an exploded view of an embodiment of the apparatus of the present invention.

FIG. 2 illustrates a cross-sectional view of an embodiment of the apparatus of the present invention.

FIG. 3 illustrates an exploded view of an embodiment of the apparatus of the present invention.

FIG. 4 illustrates a cross-sectional view of an embodiment of the apparatus of the present invention.

FIG. 5 illustrates an exploded view of an embodiment of the apparatus of the present invention.

### 4. DESCRIPTION OF CERTAIN EMBODIMENTS OF THE INVENTION

The present invention provides an apparatus for use in cooking sliced pepperoni, salami or the like by microwave energy. The apparatus will allow the user to cook these items in a microwave oven, while safely and conveniently containing the fat and grease that emanates from the food products during the cooking process. The apparatus includes a base unit 103 that supports the cooking surface 102, grease collection surface 109, as well as hold the released fat and grease in its reservoir 105 element. The apparatus also includes a lid 100 that contains the released fat and grease in the apparatus.

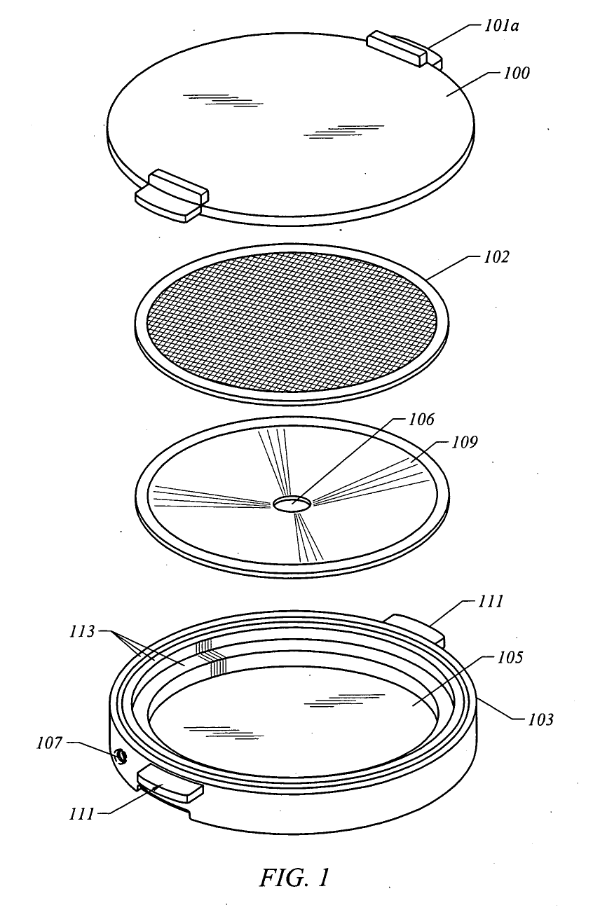

FIG. 1 illustrates an exploded view of an embodiment of the apparatus. The base 103 is shown with nested supporting ridges. The supporting ridges 113 in the base support the grease collection surface 109, the cooking surface 102, and the lid 100. Also shown in this drawing are handles 111 attached to the sides of the base 103. Shown as element 107 in the drawing is a sealable drain 107 located in the base. This base drain allows the user to drain fat/grease from the reservoir 105.

The cooking surface 102 is shaped and sized such that it can be supported by the base 103 structure, and allows for placement of pepperoni slices 110 and the like on it. This embodiment of the cooking surface 102 includes a mesh type surface that supports the pepperoni, while at the same time allowing the fat and grease released during the cooking process to flow down onto the grease collection surface, and then into the base 103 and its reservoir 105. The grease collection surface slants downwards from the edges, and includes an opening 106 that directs the fat and grease released during the cooking process into the reservoir 105 portion of the base. Although the grease collection surface may not be a required element of the invention, it is a suggested element of the apparatus since its use may reduce the risk of grease spillage.

The lid 100 is shown in a size and shape that allows it to be supported by the base and/or cooking surface 102, while also covering the cooking surface 102. The lid allows the cooking process to proceed without grease escaping from the apparatus. Handles 101(a) are shown on the lid that assist the user in manipulating the lid. This handle configuration, wherein the handles 101(a) are located on opposing sides of the lid 100 allows the user to align the lid handles 101(a) with the two base handles 111, in such a way as to allow the user to grasp both a base handle 111 and lid handle 101(a) in each hand. This would allow the user to manipulate the entire apparatus in a more controlled manner.

The embodiment illustrated in this drawing allows for the lid, cooking surface, and grease collection surface to be removed from the base for cleaning after use.

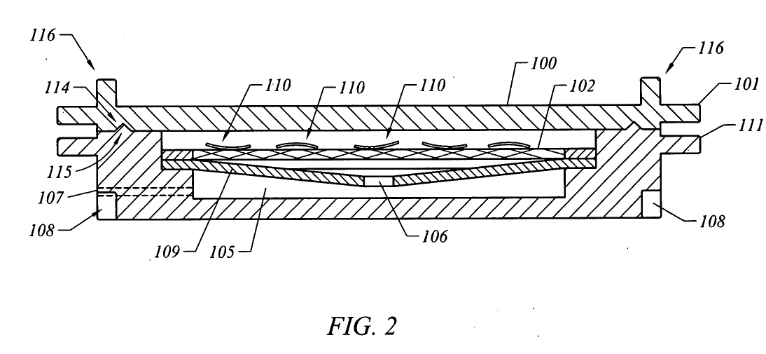

FIG. 2 illustrates a cross-sectional view of an embodiment of the apparatus of the present invention. The drawing illustrates an embodiment of the invention with the base 103, cooking surface 102, grease collection surface 109, and lid 100 assembled. The drawing also includes pepperoni 110 slices located on the cooking surface 102. The grease collection surface 109 slopes down from the outside edges, thus allowing the free flow of the released grease to the opening 106 in the middle of the grease collection surface. The released grease can then fall into the reservoir 105 in the base 103. The drawing illustrates the base drain 107, which allows the user to remove grease from the base 103 in a convenient and controlled manner.

Base notches 108 are located on the bottom edge of the base 103. These notches allow the user to conveniently stack multiple units of the apparatus on top of each other by aligning the base notches 108 with the corresponding lid ridges 116. The invention could also function in a similar fashion if the lid and base of stacked units were aligned with one or more protrusions or ridges located on the bottom of the base, along with notches or other indentations located on the top of the lid.

FIG. 2 also illustrates the centering ridges located on the base, as well as the centering notches 114 located on the lid 100. These centering notches 115 and ridges 114 help to keep the lid 100 and base 100 properly aligned. The invention could also function in a similar fashion if the lid and base were aligned with one or more protrusions or ridges located on the bottom of the lid, along with notches or other indentations located on the top of the base.

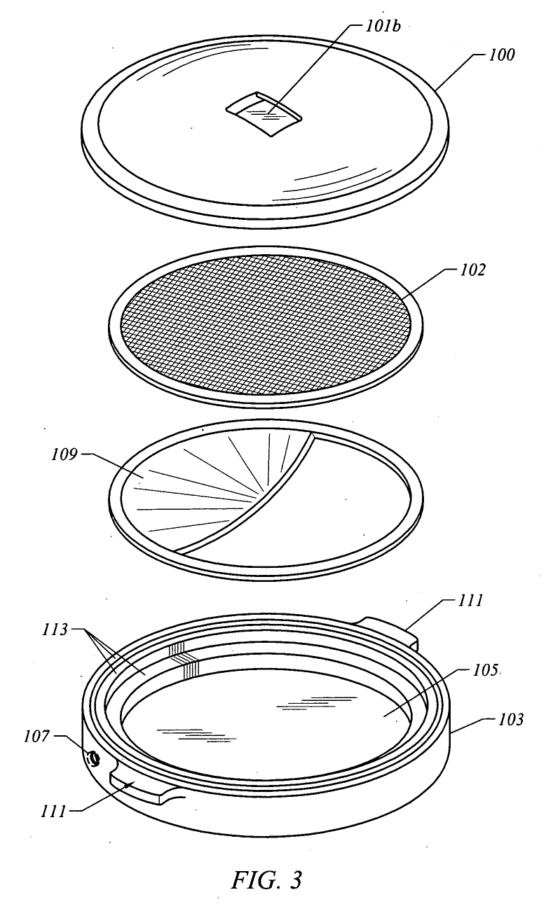

FIG. 3 illustrates an exploded view of an embodiment of the apparatus. The base 103 unit and cooking surface 102 in FIG. 3 are similar to those shown in FIG. 1, however the embodiment shown in FIG. 3 illustrates several differences in the lid 100 structure and grease collection surface 109. The base 103 is shown with nested supporting ridges. The supporting ridges 113 in the base support the grease collection surface 109, the cooking surface 102, and the lid 100. The lid 100 incorporates a handle 101(b) on the top of the lid 100.

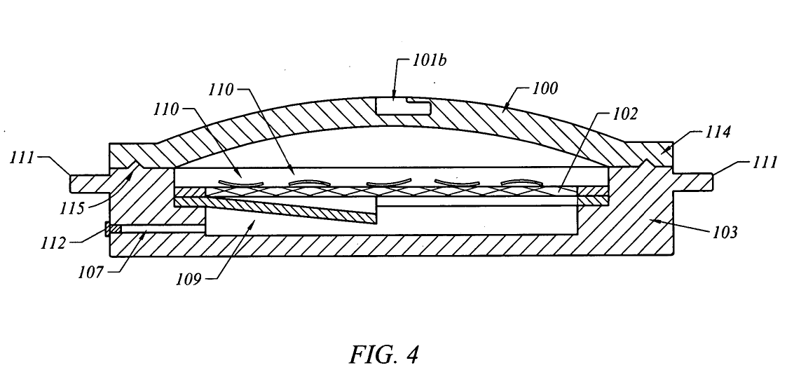

A cross sectional view of this lid handle 101(b) arrangement is shown in FIG. 4. This handle configuration, wherein the handle 101(b) is located on top of the lid 100 allows the user to manipulate the lid. The lid handle configuration illustrated in FIG. 3 allows the user to manipulate the lid with the thumb and fingers of one hand. The lid 100 is shown in a size and shape that allows it to be supported by the base and/or cooking surface 102, while also covering the cooking surface 102. The lid allows the cooking process to proceed without grease escaping from the apparatus.

The cooking surface 102 is shaped and sized such that it can be supported by the base 103 structure, and allows for placement of pepperoni slices 110 and the like on it. This embodiment of the cooking surface 102 includes a mesh type surface that supports the pepperoni, while at the same time allowing the fat and grease released during the cooking process to flow down onto the grease collection surface, and then into the base 103 and its reservoir 105.

The grease collection surface slants downwards from the side such that grease released during the cooking process can land on it and flow into the reservoir. The grease collection surface illustrated in FIG. 3 is configured such that it covers a portion of the reservoir. The grease collection surface shown in FIG. 3 covers approximately 50% of the surface area of the base, however it is anticipated that various configurations of the invention disclosed herein may include different sized collection surfaces ranging from a small lip, to one that covers nearly the entire reservoir. The collection surface 109 in this configuration allows the user to more easily manipulate the apparatus, including tilting the apparatus during the grease removal process via the base drain 107.

The embodiment illustrated in FIG. 3 allows for the lid, cooking surface, and grease collection surface to be removed from the base for cleaning after use.

FIG. 4 illustrates a cross-sectional view of an embodiment of the apparatus of the present invention. The base 103 is shown with nested supporting ridges. The supporting ridges 113 in the base 103 support the grease collection surface 109, the cooking surface 102, and the lid 100. The lid 100 incorporates a handle 101(b) on the top of the lid 100.

The drawing illustrates an embodiment of the invention with the base 103, cooking surface 102, grease collection surface 109, and lid 100 assembled. The drawing also includes pepperoni 110 slices located on the cooking surface 102. The grease collection surface 109 slopes down from the outside edge, thus allowing the free flow of the released grease to the reservoir 105 in the base 103. The drawing illustrates the base drain 107, which allows the user to remove grease from the base 103 in a convenient and controlled manner. Also shown is the base drain plug 112, located at the exterior opening of the base drain 107. It is anticipated that the base drain 107 and base drain plug 112 will allow the user safely drain grease released during the cooking process in a safe and controlled manner.

FIG. 4 also illustrates the centering ridges located on the base, as well as the centering notches 114 located on the lid 100. These centering notches 115 and ridges 114 help to keep the lid 100 and base 100 properly aligned. The invention could also function in a similar fashion if the lid and base were aligned with one or more protrusions or ridges located on the bottom of the lid, along with notches or other indentations located on the top of the base.

As in FIG. 3, FIG. 4 also illustrates a grease collection surface that slants downwards from the side such that grease released during the cooking process can land on it and flow into the reservoir. The grease collection surface illustrated in FIG. 4 is configured such that it covers a portion of the reservoir. The grease collection surface shown in FIG. 3 covers approximately 50% of the surface area of the base, however it is anticipated that various configurations of the invention disclosed herein may include different sized collection surfaces ranging from a small lip, to one that covers nearly the entire reservoir. The collection surface 109 in this configuration allows the user to more easily manipulate the apparatus, including tilting the apparatus during the grease removal process via the base drain 107.

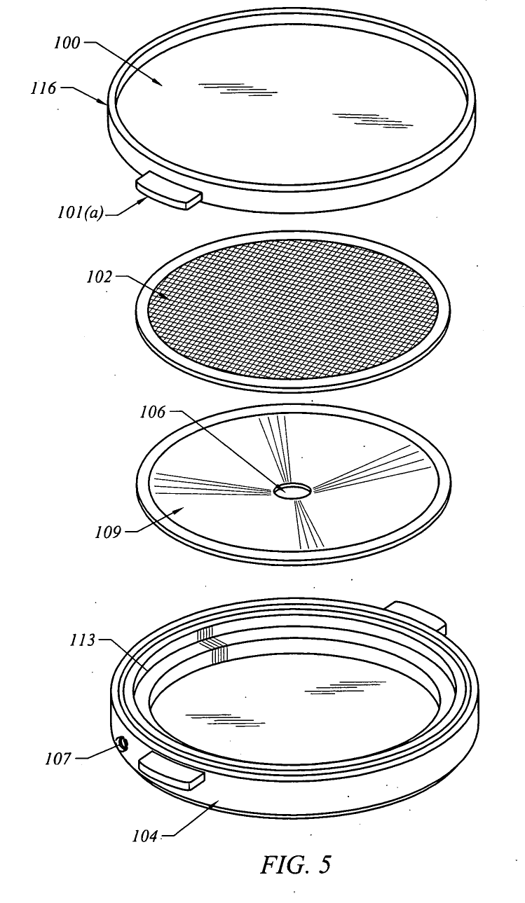

FIG. 5 illustrates an exploded view of an embodiment of the apparatus. The look and function of the cooking surface 102 and grease collection surface 109 are identical to those found in FIG. 1. However, FIG. 5 illustrates a different lid 100 and base 103 configuration. The lid 100 structure in FIG. 5 shows a lid ridge 116 on the top and outside of the lid 100. The purpose of the lid ridge 104 is to fit into the base groove 104 of another device when multiple apparatus are stacked. The base groove 104 is a groove located on the bottom and outside of the base. If, as in FIG. 5, the lid ridge 116 and the base groove 104 both fully surround the lid and base (respectively), the base groove of one apparatus could fit over, and be supported by, the lid ridge of a second apparatus when stacked.

What is claimed is:

1. A utensil for use in cooking products by microwave energy wherein the products contain fats that are released as liquid grease during the cooking comprising:
a. A base member, wherein said base is:
i. capable of collecting liquid grease, and
ii. of a material stable against deformation when contacted by liquid grease;
b. A generally horizontal cooking surface supported by the base, and permeable to liquid grease on which generally flat food products can be placed;
i. Said cooking surface supported by said base, and
ii. Said cooking surface located over the base, to permit flow of liquid grease from the cooking surface into the base; and
c. A cover, located generally over the base and cooking surface.

2. A utensil for use in cooking products by microwave energy wherein the products contain fats that are released as liquid grease during the cooking comprising:
a. A base member, wherein said base:
i. is capable of collecting liquid grease, and
ii. comprises a material stable against deformation when contacted by hot grease, and
iii. comprises a generally horizontal cooking surface located parallel to and above the base to permit flow of liquid grease from the cooking surface into the reservoir in the base, where said cooking surface is:
1. permeable to liquid grease; and
2. on which generally flat food products can be placed; and
b. A cover, located generally over the base and cooking surface.

3. A utensil as in claim 1 or 2, wherein said utensil further comprises a grease collection surface, located generally below the cooking surface, and sloped downwards from the outside of the base.

4. A utensil as in claim 3, wherein said grease collection surface further comprises an aperture at its lowest level relative to its outside edge.

5. A utensil as in claim 3, wherein said grease collection surface partially encircles and overlays the reservoir portion of the base.

6. A utensil as in claim 3, wherein said base generally comprises a pan shape.

7. A utensil as in claim 3, wherein said base further comprises a means to drain liquid from the base.

8. A utensil as in claim 7, wherein said means to drain liquid from the base comprises a sealable opening in the base.

9. A utensil as in claim 1 or 2, wherein said base further comprises
a. a ridge located at the top edge of the base; and
b. a notch located at the bottom edge of the lid.

10. A utensil as in claim 3, wherein said cooking surface is a generally horizontal planar surface further comprising a plurality of holes permeable to liquid.

11. A utensil as in claim 3, wherein said base, cooking surface, and cover are composed of a plurality of microwave transparent materials.

12. A utensil as in claim 3, further comprising a handle means mounted on said cover.

13. A utensil as in claim 3, further comprising a handle means located on the base.

14. A utensil as in claim 3, further comprising a means for stacking a plurality of the said utensils onto each other.

15. A utensil as in claim 14, wherein the means for stacking the utensils comprise:
a. A plurality of grooves located on the bottom and exterior portion of the base; and
b. A plurality of ridge encircling the top of the lid.

16. A utensil as in claim 14, wherein the means for stacking the utensils comprise:
a. A plurality of grooves located on the top of the lid; and
b. A plurality of ridges encircling the bottom and exterior portion of the base.

17. A utensil as in claim 3, wherein the a plurality of the components of the utensil are visually transparent.
